(19) United States
(12) Patent Application Publication
(10) Pub. No.: US 2007/0006121 A1
(43) Pub. Date: Jan. 4, 2007

(54) Development activity recipe

(75) Inventors: Eduardo A. Jezierski, Sammamish, WA (US); Stuart John Harding Kent, Canterbury (GB); Wojtek Kozaczynski, Duvall, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/139,901

(22) Filed: May 27, 2005

(51) Int. Cl. G06F 9/44

(52) U.S. Cl. 717/101

(57) ABSTRACT

An abstraction can be used to describe interactions with a developer and development actions that should be automated. A recipe defines (1) arguments whose values may be collected to execute the actions, (2) value providers that can query the environment for argument values, (3) sequences of actions that are to be executed and how arguments are passed to the action, (4) methods to interact with the developer to get argument values from him, as opposed to getting the argument values through value providers, and (5) the capability whereby a recipe may spawn one or more further recipes, thereby allowing guidance to be revealed in stages and at the point it is needed.

### FIELD OF THE INVENTION

The present invention relates generally to the field of computer software development and, more particularly, to code-based software solution development guidance.

### BACKGROUND OF THE INVENTION

It is desirable to provide an easy to understand abstraction that guidance authors can use to describe interactions with a developer and to describe development actions that should be automated. The existing, commonly used abstraction is that of a wizard. A wizard, however, only describes the interactions with the user, but does not explicitly describe what operations are performed as the result of executing the wizard. Generally, a wizard's actions are intertwined with wizard code.

In view of the foregoing, there is a need for systems and methods that overcome such deficiencies.

### SUMMARY OF THE INVENTION

The following summary provides an overview of various aspects of the invention. It is not intended to provide an exhaustive description of all of the important aspects of the invention, nor to define the scope of the invention. Rather, this summary is intended to serve as an introduction to the detailed description and figures that follow.

This present invention is directed to an easy to understand abstraction that guidance authors can use to describe interactions with a developer and development actions that should be automated. An embodiment of the invention, referred to herein as “recipe”, defines (1) arguments whose values may be collected to execute the actions, (2) value providers that can query the environment for argument values, (3) sequences of actions that are to be executed and how arguments are passed to the action, (4) methods to interact with the developer to get argument values from him, as opposed to getting the argument values through value providers, and (5) the capability whereby a recipe may spawn one or more further recipes, thereby allowing guidance to be revealed in stages and at the point it is needed.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a flow diagram of an example recipe execution method in accordance with the present invention;

FIG. 2 is a flow diagram of another example recipe execution method in accordance with the present invention;

FIG. 3 is a block diagram of exemplary recipe framework elements in accordance with the present invention;

FIG. 4 is a diagram of an exemplary logical model of recipes in accordance with the present invention;

FIG. 5 is a diagram of an exemplary logical model of recipes in a development environment in accordance with the present invention;

FIG. 6 is a diagram of an exemplary model of recipes and recipe references in accordance with the present invention;

FIG. 7 is a diagram of an exemplary guidance package manager user interface component in accordance with the present invention;

FIG. 8 is a block diagram representing an exemplary network environment having a variety of computing devices in which the present invention may be implemented; and

FIG. 9 is a block diagram representing an exemplary non-limiting computing device in which the present invention may be implemented.

### DETAILED DESCRIPTION OF ILLUSTRATIVE EMBODIMENTS

The subject matter is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

The present invention will be more completely understood through the following detailed description, which should be read in conjunction with the attached drawings. In this description, like numbers refer to similar elements within various embodiments of the present invention. The invention is illustrated as being implemented in a suitable computing environment. Although not required, the invention will be described in the general context of computer-executable instructions, such as procedures, being executed by a personal computer. Generally, procedures include program modules, routines, functions, programs, objects, components, data structures, etc. that perform particular tasks or implement particular abstract data types. Moreover, those skilled in the art will appreciate that the invention may be practiced with other computer system configurations, including handheld devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices. The term computer system may be used to refer to a system of computers such as may be found in a distributed computing environment.

Aspects of the present invention separate concepts of activities and interactions with the user and describe them declaratively. An embodiment of the invention, referred to herein as “recipe”, defines (1) arguments whose values may be collected to execute the actions, (2) value providers that can query the environment for argument values, (3) sequences of actions that are to be executed and how arguments are passed to the action, (4) methods to interact with the developer to get argument values from him, as opposed to getting the argument values through value providers, and (5) the capability whereby a recipe may spawn one or more further recipes, thereby allowing guidance to be revealed in stages and at the point it is needed.

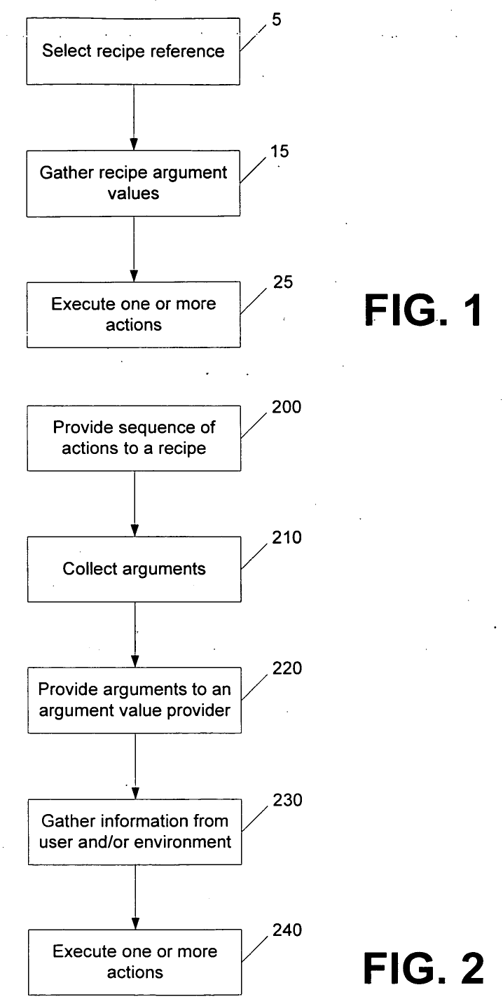

A recipe is a specification that is a sequence of actions performed on behalf of a user by, or within, a host. FIG. 1 is a flow diagram of an example recipe execution method in accordance with the present invention. When a recipe reference is selected at step 5, the recipe is executed. Execution of a recipe involves gathering recipe argument values at step 15, and executing one or more actions at step 25 that can create or modify solution artifacts or perform some other operation in the environment such as registering a queue or running a script. In other words, each of the actions performs a task using arguments (i.e., information). Arguments get passed to the action. A recipe may acquire arguments by either finding arguments without intervention from a user, or arguments may be obtained from a user. Obtaining arguments from a user may involve a value gathering strategy. A wizard may be used to get data for a recipe.

Put another way, a recipe is a program that creates or transforms solution artifacts on behalf of a developer. Recipes may be grouped into recipe clusters that support a set of related development activities such as, for example, development of smart clients. Thus, a recipe provides a simple and elegant way of packaging code-development guidance that can be integrated with software development environments, such as Microsoft Visual Studio (VS). Aspects of the invention include separation of arguments from argument value gathering strategies, declaration of the recipe behavior as a sequence of un-doable actions, and decoupling of a recipe from the hosting environment.

A recipe may have one or more recipe references that are shown in the development environment. If the recipe reference is selected, then the recipe is executed. Based on their behavior, recipes may be divided into bound recipes and unbound recipes. Bound recipes are recipes whose references are bound with specific development environment (e.g., Microsoft Visual Studio) solution elements (e.g., folders, projects, or items) and are made visible when those elements are selected. Unbound recipes are recipes which are not bound to specific elements. References of unbound recipes inspect currently selected solution element(s) and decide, based on a condition, if they should be made visible. Bound and unbound recipes are described further herein.

An example recipe may automate creation of a client WebService service gateway to facilitate testing the client in connected and disconnected modes. Such a recipe may define the following arguments, actions, and user interaction: (1) arguments: web service (asmx file), client project; (2) action: create web reference in the client project, create service proxy class, create “local” service proxy class, create service gateway class, create test harness for testing the client with “real” service connection or “simulated/local” connection; and (3) user interactions: both argument values would be collected from the user (e.g., via an interface similar to a wizard).

If an author has access to implementations of the actions, which may come from a library of reusable actions, for example, a recipe can be defined declaratively. This implies that as a library of reusable actions is developed, recipes may be created using recipe definition editors (recipe definition forms a simple domain-specific language).

A recipe may comprise classes, projects, solutions, solution folders, configuration files, and scripts, for example. New classes may be generated and existing classes may be modified. Additionally, code may be inserted into class files. Items, references, and policies with regard to projects may be added or removed, and properties may be modified. Similarly, solution folders, projects, and policies may be added or removed, and solution properties may be modified. Configuration files may be created and modified. Scripts may be modified and executed.

FIG. 2 is a flow diagram of another example recipe execution method in accordance with the present invention. A sequence of actions, provided by a host, users, others, spawning recipes (described further herein), etc. is provided to a recipe, at step 200, where the tasks are automated, using a specification that describes the actions and arguments (e.g., using XML). The arguments are collected, at step 210, and provided to an argument value provider, at step 220, which gets information from a user and environment, at step 230. Information may be obtained from a user (e.g., via wizards, prompts, dialogs, for example) or a host. Thus, in some cases, actions may be performed on a user's behalf with minimal user interaction. Desirably, a host guides a user in the flow. This makes it easy to quickly modify a behind the scenes step. The automated tasks are non-visual tasks. One or more actions are then executed at step 240.

There is no dependency (relationship) between recipes, except that a recipe can spawn another recipe. Code-based guidance often includes a large number of steps and may involve a number of choices. Subsequent steps often depend on the steps performed before, and steps can call for a developer to complete work using various development tools. A single recipe cannot be used to encode all the steps at once. Multiple recipes may be used, but then the issue is how those recipes are intended to work together, and how they can be discovered at the right time and in the right context. Recipe spawning solves this problem, where the results of applying one recipe includes the spawning of other recipes. The invocation of the spawned recipes can be delayed. By using spawning, only a few steps need be taken in a recipe, and the next steps can be controlled by deciding what recipes to spawn next. By delaying the invocation of spawned recipes, a developer can complete work using the various development tools available, in between the application of recipes. In this way, guidance is revealed to a developer in stages and at the point it is needed.

A recipe is independent of its implementation. However, an environment that executes recipes may be implemented in the host. An example environment, called recipe framework, provides support for recipes. The framework desirably interprets declarative specification of recipes (e.g., the specification is in XML), and executes argument value providers that can obtain argument values from the environment, without interacting with the developer. The framework may invoke a dialog with the user to collect argument values that only the user can provide (such as selected elements in a Visual Studio solution). It prepares argument sets for actions, and calls actions in the sequence defined in the recipe. If any of the actions fails, the framework may call the completed actions in the reverse order to undo their changes.

An exemplary recipe framework is a software component that can run in different hosts. For example, the framework may be integrated with Visual Studio as a VS package. Such an example integration allows a developer to manage recipe clusters, apply their recipes, and unfold cluster templates from within VS.

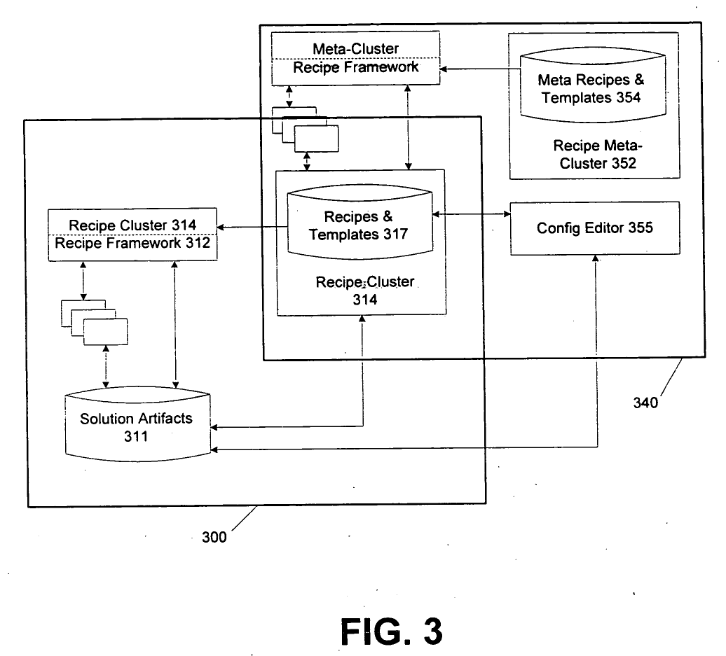

To be managed, recipe clusters may be packaged and installed as a unit. Example relationships between the framework, recipe clusters, and VS are shown in FIG. 3.

An example framework may be used to enable and disable recipe clusters. Moreover, the framework may activate recipe references and execute recipes. To make recipes and templates of a cluster available (visible) in a VS solution, the cluster is enabled. Conversely, a cluster can be disabled, which means that its recipes and templates are removed from (i.e., made invisible in) a solution. The framework desirably provides means for the developer to enable and disable recipe clusters. This is done through enabling and disabling cluster recipes and filtering cluster templates.

In an example embodiment, templates may be either VS templates or T3 (Text Template Transformation) templates, for example. VS templates may be solution templates, project templates, or item templates, for example. Solution and project templates are described in XML and are unfolded (expanded) by the VS template engine. Item templates are described in the target language (e.g., C# or Visual Basic (VB)) with parameter substitution and are also unfolded by VS. T3 templates are text templates which take the form of an arbitrary target text interleaved with T3 directives and so-called scriptlets, C# or VB code fragments, for example, that when executed, return strings that are inserted in place of their place. T3 templates are desirably unfolded by the T3 engine called from recipe actions.

A VS solution or project template may have a recipe associated with it. When a template with a recipe is expanded, the recipe is executed to collect template parameters and perform actions on the result of the expansion or some additional operations in the environment.

Elements in FIG. 3 have been grouped into two groups 300, 340. The group 300 is the “solution development group”. It shows elements that participate in solution development using the recipe framework 312 and a recipe cluster 314. The group 340 is called a “recipe cluster authoring group”. It shows elements participating in development of a recipe cluster 314.

To use a recipe cluster to develop a solution, a developer desirably installs the recipe framework 312, installs the cluster 314, and opens the development environment (e.g., VS) and enables the cluster. The cluster can be enabled in one of two ways, for example. The developer can use a framework command to open a dialog, select the clusters, and enable it. This is done when the cluster is enabled on an existing solution. Alternatively, the developer can start the solution from a solution template that has a recipes associated with it and/or contains recipe and template references 317. The clusters that those recipes and templates belong to are desirably automatically enabled. After enabling the cluster, the developer can use its recipes and templates.

Development of a recipe cluster for use in VS comprises, for example: definition of recipes, declaration of so-called launch points where recipe references will be shown in the VS interface, development of recipes' actions, definition of VS templates and T3 templates, and specification of wizards that may be used to get argument values from a developer. This may be done with the help of a recipe meta-cluster 352 and editors 355 (recipe cluster definition editor and template editors). A recipe meta-cluster 352 is a cluster of recipes and templates 354 to develop recipe clusters.

A recipe supports a developer use-case; that is, it supports the developer in performing a well defined activity comprised of actions that can transform solution artifacts 311. A recipe is associated with a software asset such as an application framework or an application block or a pattern. It helps use the asset while developing a solution.

As described above, a recipe is executed inside a recipe framework 314. The framework can run in different hosts; for example, it can run in a console application.

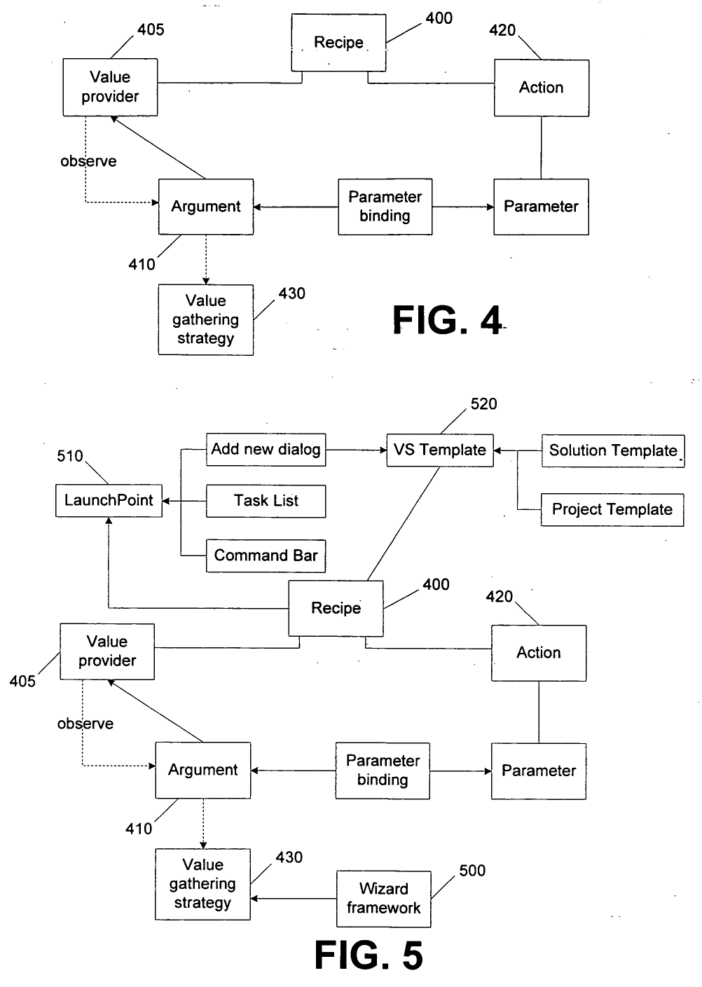

FIG. 4 shows an example logical model of recipes. A recipe 400 has a number of arguments 410 and actions 420. Arguments 410 are defined either as required or optional. A required argument is not null when actions are executed. If an argument is defined as optional, it means that actions can cope with null value of the argument.

When the framework executes a recipe, it gathers values of its arguments. The values may be obtained in two ways, for example. Each argument 410 may have a value provider 405. A provider 405 implements an interface that the framework can use to obtain argument values. The framework calls value providers of required arguments before it calls the value gathering strategy 430. If after executing the value gathering strategy 430, a required argument is still null, the framework calls its provider again. Value providers 405 can also observe changes to other arguments 410 (e.g., subscribe to those changes). This is represented in FIG. 4 by the <<observe>> dependency. When an observed argument changes value, the framework calls the providers that observe it so they can reset values of their own arguments. This mechanism is used to “cascade” argument values and defaulting.

Moreover, argument values can be provided by calling a value gathering strategy, which may implemented as a wizard presented to the user. This is where the user can provide argument values “by hand”.

The framework verifies that it has all argument values it needs to execute its actions, and executes the actions. Action parameters are binded with argument values. Actions are called in a defined sequence, passing them their arguments. If an action fails, it desirably calls “undo” on the executed actions in a reversed sequence.

FIG. 5 show an extended recipe model including elements introduced by the VS host. As a host, VS provides (1) launch points 510, that is, places in the VS interface where references to recipes 400 can be displayed, so the developer can start (launch) their execution; (2) extensibility points for the framework to display its own user interfaces; (3) a wizard framework 500 to implement a value gathering strategy 430; and (4) a template expansion engine that unfolds VS templates 520 and executes recipes associated with them.

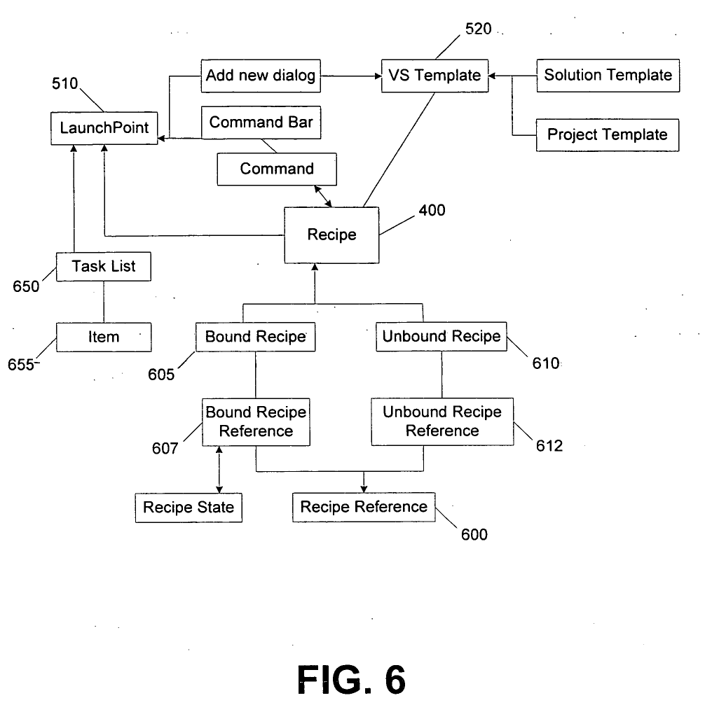

FIG. 6 shows elements of an example recipe model that are helpful in explaining different kinds of recipes and the recipes lifecycle. A recipe 400 has one or more references 600. A reference is an object that the framework uses to associate recipes with launch points, execute recipes, and store their state.

A bound recipe 605 is a recipe that is associated with a solution element. Every time a bound recipe is associated with a solution element, a bound recipe reference 607 is created for that recipe and that element. The element is stored in the target property of the reference. A bound recipe can be associated with a solution by a mechanism, such as (1) declaratively: a reference to the recipe is defined in a project or solution template, or (2) programmatically: a reference to the recipe is created by an action of another recipe.

A bound recipe may be launched in the following way. Recipes are represented in a VS user interface by commands. When a command bar (a kind of a launch point) is selected on a solution element or somewhere else, VS asks every command associated with this command bar if it should be displayed (e.g., via QueryStatus). The framework, which registered commands with VS, identifies the recipe represented by the command. If the recipe is a bound recipe, the framework checks if there is a reference for this recipe that is associated with the selected solution element. If there is, the command is displayed and is “connected” to that reference. If the command is selected, the reference executes the recipe.

A bound recipe can be either recurring or not. A reference to a recurring recipe is desirably not deleted after it executes its recipe. In other words, once a recurring recipe is associated with a solution element, it can be executed at this element many times. A reference to a non-recurring recipe is desirably removed after it executes its recipe.

A bound recipe can be spawned with an initial state or can be suspended during argument value gathering. In both cases, the recipe state (values of its arguments) may be stored by the framework.

A bound recipe behaves like a task. It is associated with a solution element ready to do its work. This is why references to bound recipes are desirably shown in a tab of a task list 650. The task list 650 is one of the launch points for bound recipes; items in the task list are directly mapped into a recipe reference and selection of an item 655 launches (executes) the recipe.

An unbound recipe 610 has only one reference that is not associated with any element. Instead, the reference contains a target condition. An unbound recipe may be launched in the following way, for example. The starting point is the same; VS asks a command associated with the selected command bar if it should be displayed. The framework identifies the recipe represented by the command, determines that it is an unbound recipe, retrieves its only reference 612 and calls the target condition passing it the selected solution element. The condition checks if the reference, or more precisely the command that represents the reference, should be displayed given the selected element. This approach allows unbound recipes to associate themselves not with specific solution element instances, but with groups of instances. For example, the target condition can check if the selected element is C# project and return “true” only if that is the case.

Unbound recipes do not have the recurring property. They also do not have an initial state and cannot be suspended. By design, unbound recipes desirably behave like recurring recipes that apply to a selected set of solution elements.

A recipe cluster is a named collection of recipes, templates, and actions. A cluster may be first installed on a developer's workstation and then enabled from within VS to be usable. A recipe cluster may contain the following artifacts: recipe cluster configuration file; wizard configuration file; zero, one or more include configuration files (configuration file fragments that can be included in the wizard or recipe configuration files); zero, one or more VS solution templates; zero, one or more VS project or multi-project templates; zero, one or more T3 templates; and zero, one or more DLLs implementing recipe actions.

A toolkit (e.g., a guidance automation toolkit) allows a user to make reusable code and pattern assets directly available in applications, such as Microsoft's Visual Studio 2005.

A toolkit is designed to simplify integrating reusable code into applications, allowing architects to automate development activities that developers would usually have to perform manually, often by following a series of instructions. By using the toolkit, architects can also ensure that repetitive and often error-prone activities are performed in a consistent way, streamlining and accelerating the development process.

The toolkit can be used with assets developed in-house or by third parties. These assets can be exposed to developers, and in some cases, configured by using configuration files, templates and wizards.

An example guidance automation toolkit comprises elements that work together to provide automation functionality, including recipes, actions, T3 templates, wizards, type converters, and VS templates. Recipes can be executed at particular solution elements, or at a group of solution elements that share certain characteristics (for example, all C# projects).

Actions are atomic units of work called by recipes in a defined sequence. The sequence is specified in the recipe definition. An action accepts an input, either from arguments that have been gathered by the calling recipes or output from an action executed earlier in the sequence, for example. Recipe actions are desirably specified in the recipe definition.

As described above, the T3 template comprises a combination of text and scriptlets. Text is inserted into the template output as is. Scriptlets are expressions in Visual Basic or C#, for example, that when executed, return a string that is directly inserted into the output stream of the template. Templates are expanded by the T3 engine included with the guidance automation toolkit.

Wizards are value gathering strategies used to gather values of recipe arguments. Any recipe can have a wizard associated with it. A wizard walks the developer through one or more steps, which are displayed as pages of the wizard.

Type converters validate the value of a field and convert them from their user interface representation to a type representation.

Visual Studio templates are written in XML, for example, and may be used by Visual Studio to create solutions or add one or more projects or items to an existing solution. The templates are expanded by the Visual Studio template engine. Using the guidance automation toolkit, Visual Studio templates can be associated with recipes. This association means that when a template is unfolded, the wizard extension calls the recipe to let it collect parameter values (arguments) for the expansion and then, after the template is unfolded, to execute actions that may further transform solution artifacts created by the template.

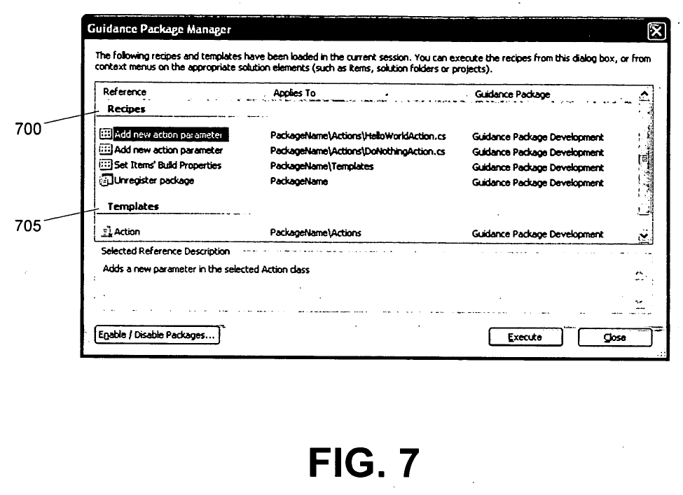

Each of these elements may be collected together, along with a configuration file, into guidance packages, which are packaged and then installed as a unit. These guidance packages can be managed from a user interface component, such as that shown in FIG. 7. Desirably, recipes 700 and templates 705 are displayed and can be modified or executed, for example. Once a guidance package is installed and enabled for a particular solution, recipes can be executed to carry out the required tasks.

Thus, to help with guidance package development, the guidance automation toolkit desirably includes a guidance package development template, which unfolds to create a solution for guidance package development. This solution includes the elements needed to create a guidance package. The elements can be modified or new elements may be created using the existing elements as a guideline. The guidance automation toolkit also desirably includes documentation that guides a user through the guidance package development process.

Exemplary Networked and Distributed Environments

One of ordinary skill in the art can appreciate that a computer or other client or server device can be deployed as part of a computer network, or in a distributed computing environment. In this regard, the present invention pertains to any computer system having any number of memory or storage units, and any number of applications and processes occurring across any number of storage units or volumes. The present invention may apply to an environment with server computers and client computers deployed in a network environment or distributed computing environment, having remote or local storage. The present invention may also be applied to standalone computing devices, having programming language functionality, interpretation and execution capabilities for generating, receiving and transmitting information in connection with remote or local services.

Distributed computing facilitates sharing of computer resources and services by direct exchange between computing devices and systems. These resources and services include the exchange of information, cache storage, and disk storage for files. Distributed computing takes advantage of network connectivity, allowing clients to leverage their collective power to benefit the entire enterprise.

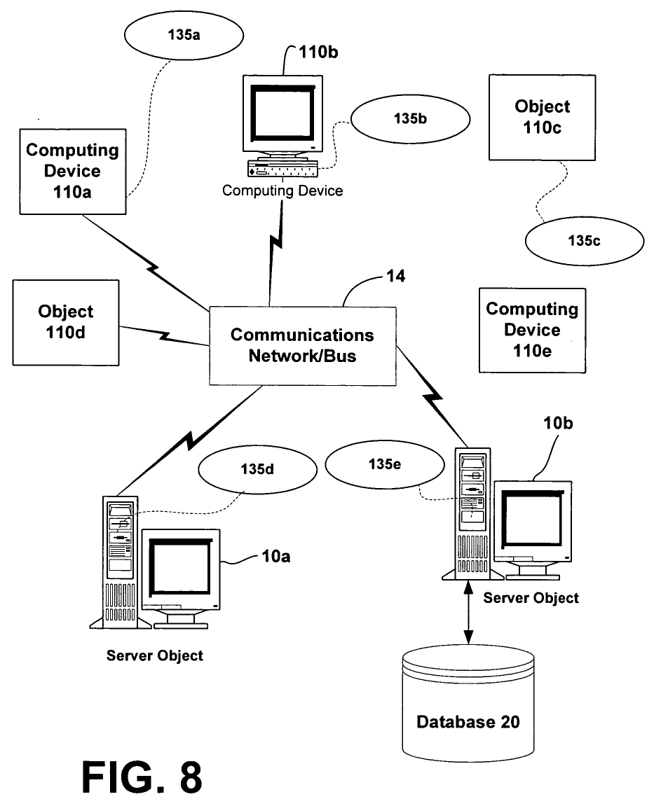

FIG. 8 provides a schematic diagram of an exemplary networked or distributed computing environment. The distributed computing environment comprises computing objects 10a, 10b, etc. and computing objects or devices 110a, 1110b, 1110c, etc. These objects may comprise programs, methods, data stores, programmable logic, etc. The objects may comprise portions of the same or different devices such as PDAs, televisions, MP3 players, televisions, personal computers, etc. Each object can communicate with another object by way of the communications network 14. This network may itself comprise other computing objects and computing devices that provide services to the system of FIG. 8. In accordance with an aspect of the invention, each object 10a, 10b, etc. or 110a, 110b, 110c, etc. may contain an application that might make use of an API, or other object, software or hardware in accordance with the invention.

It can also be appreciated that an object, such as 110c, may be hosted on another computing device 10a, 10b, etc. or 110a, 110b, etc. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many of the networks are coupled to the Internet, which provides the infrastructure for widely distributed computing and encompasses many different networks.

The network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 8, computers 110a, 110b, etc. can be thought of as clients and computer 10a, 10b, etc. can be thought of as the server where server 10a, 10b, etc. maintains the data that is then replicated in the client computers 110a, 110b, etc., although any computer could be considered a client, a server, or both, depending on the circumstances.

A server is typically a remote computer system accessible over a remote network such as the Internet. The client process may be active in a first computer system, and the server process may be active in a second computer system, communicating with one another over a communications medium, thus providing distributed functionality and allowing multiple clients to take advantage of the information-gathering capabilities of the server.

Thus, FIG. 8 illustrates an exemplary networked or distributed environment, with a server in communication with client computers via a network/bus, in which the present invention may be employed. In more detail, a number of servers 10a, 10b, etc., are interconnected via a communications network/bus 14, which may be a LAN, WAN, intranet, the Internet, etc., with a number of client or remote computing devices 110a, 110b, 110c, 110d, 110e, etc., such as a portable computer, handheld computer, thin client, networked appliance, or other device, in accordance with the present invention.

In a network environment in which the communications network/bus 14 is the Internet, for example, the servers 10a, 10b, etc. can be Web servers with which the clients 110a, 110b, 110c, 110d, 110e, etc. communicate via any of a number of known protocols such as HTTP. Servers 10a, 10b, etc. may also serve as clients 110a, 110b, 110c, 110d, 110e, etc., as may be characteristic of a distributed computing environment. Communications may be wired or wireless, where appropriate. Client devices 110a, 110b, 110c, 110d, 110e, etc. may or may not communicate via communications network/bus 14, and may have independent communications associated therewith. Each client computer 110a, 110b, 110c, 110d, 110e, etc. and server computer 110a, 110b, etc. may be equipped with various application program modules or objects 135 and with connections or access to various types of storage elements or objects, across which files may be stored or to which portion(s) of files may be downloaded or migrated. Any computer 10a, 10b, 110a, 110b, etc. may be responsible for the maintenance and updating of a database 20 or other storage element in accordance with the present invention, such as a database or memory 20 for storing data processed according to the invention. Thus, the present invention can be utilized in a computer network environment having client computers 110a, 110b, etc. that can access and interact with a computer network/bus 14 and server computers 10a, 10b, etc. that may interact with client computers 10a, 10b, etc. and other like devices, and databases 20.

Exemplary Computing Device

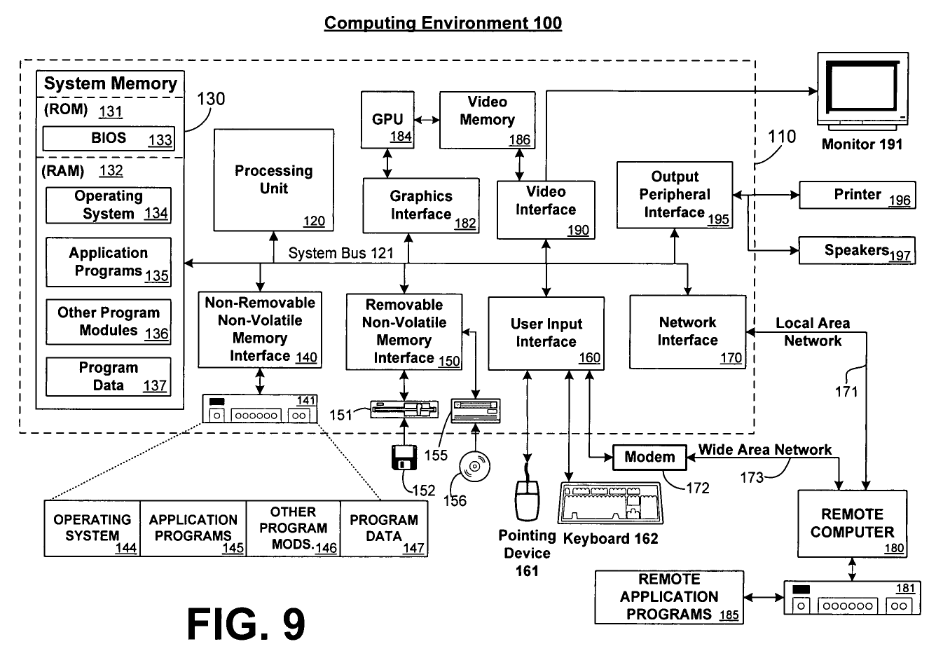

FIG. 9 and the following discussion are intended to provide a brief general description of a suitable computing environment in which the invention may be implemented. While a general purpose computer is described below, this is but one example, and the present invention may be implemented with a thin client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can be implemented via an operating system, for use by a developer of services for a device or object, and/or included within application software that operates in accordance with the invention. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations and protocols. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. The invention may also be practiced in distributed computing environments where tasks are performed by remote processing devices that are linked through a communications network/bus or other data transmission medium. In a distributed computing environment, program modules may be located in both local and remote computer storage media including memory storage devices, and client nodes may in turn behave as server nodes.

FIG. 9 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 9, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 9 illustrates operating system 134, application programs 135, other program modules 136, and program data 137.

The computer 110 may also include other removable/non-removable, volatile/nonvolatile computer storage media. By way of example only, FIG. 9 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 9 provide storage of computer readable instructions, data structures, program modules and other data for the computer 110. In FIG. 9, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186, wherein the application variables of the invention may have impact. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 9. The logical connections depicted in FIG. 9 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 9 illustrates remote application programs 185 as residing on memory device 181. It will be appreciated that the network connections shown are exemplary and other means of establishing a communications link between the computers may be used.

There are multiple ways of implementing the present invention, e.g., an appropriate API, tool kit, driver code, operating system, standalone or downloadable software object, etc. Various implementations of the invention described herein have aspects that are wholly in hardware, partly in hardware and partly in software, as well as in software.

As mentioned above, while exemplary embodiments of the present invention have been described in connection with various computing devices and network architectures, the underlying concepts may be applied to any computing device or system. While exemplary programming languages, names and examples are chosen herein as representative of various choices, these languages, names and examples are not intended to be limiting. One of ordinary skill in the art will appreciate that there are numerous ways of providing object code that achieves the same, similar or equivalent functionality achieved by the various embodiments of the invention.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, or a receiving machine having the signal processing capabilities as described in exemplary embodiments above becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. The present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed:

1. A method for task execution, comprising:
selecting a recipe reference associated with a recipe;
gathering recipe argument values; and
executing the recipe based on the recipe argument values.

2. The method of claim 1, wherein executing the recipe comprises creating or modifying a solution artifact.

3. The method of claim 1, wherein executing the recipe comprises performing an operation in a host environment.

4. The method of claim 1, wherein gathering the recipe argument values comprises obtaining the recipe argument values from a user.

5. The method of claim 1, wherein gathering the recipe argument values comprises obtaining the recipe argument values without user intervention.

6. The method of claim 1, wherein the recipe is bound with specific development environment solution elements.

7. The method of claim 1, wherein the recipe is unbound.

8. A computer readable medium having stored thereon a recipe defining arguments, actions, and user interactions.

9. The computer readable medium of claim 8, wherein the arguments are obtained via a wizard.

10. The computer readable medium of claim 8, wherein the actions are obtained from a library of reusable actions.

11. The computer readable medium of claim 8, wherein the recipe comprises classes, projects, solutions, solution folders, configuration files, or scripts.

12. The computer readable medium of claim 8, wherein the recipe can spawn a second recipe.

13. A task execution system comprising:
a recipe; and
a recipe framework that provides support for a recipe.

14. The system of claim 13, wherein the recipe framework interprets the declarative specification of the recipe.

15. The system of claim 13, further comprising argument value providers that can obtain argument values from an environment without user interaction.

16. The system of claim 15, wherein the recipe framework executes the argument value providers.

17. The system of claim 15, wherein the recipe framework invokes a dialog with a user to collect argument values.

18. The system of claim 13, wherein the recipe framework prepares argument sets for a plurality of actions, and calls the actions in a sequence defined by the recipe.

19. The system of claim 13, wherein the recipe framework is a software component that can run in a plurality of hosts.

20. The system of claim 13, further comprising a recipe cluster comprising the recipe and a template.
